(19) United States
(12) Patent Application Publication
(10) Pub. No.: US 2013/0331175 A1
(43) Pub. Date: Dec. 12, 2013

(54) Networked Games with Payback Exceeding 100% and Non-Cash Awards

(71) Applicant: Jason Myles Mayeroff, Reno, NV (US)

(72) Inventor: Jason Myles Mayeroff, Reno, NV (US)

(73) Assignee: KETAVONG HOLDINGS, LLC, Santa Fe, NM (US)

(21) Appl. No.: 13/492,006

(22) Filed: Jun. 8, 2012

(51) Int. Cl. G06F 17/00

(52) U.S. Cl. 463/25

(57) ABSTRACT

A networked gaming system and method for use in one or more casino establishments for offering games with a payback to the player exceeding 100% of the amount wagered over time by awarding the player with non-cash awards such as merchandise and services sold in bulk by third parties offering the merchandise and services. The gaming machine and method are offered on electronic gaming machines such as slot machines and video poker machines, but may also be deployed in other forms such as on a general purpose computing device or mobile telephone in stand-alone form or connected to a network, such as the Internet.

### BACKGROUND

Electronic gaming machines (“EGMs”) offer a variety of games such as slot games, video poker games, roulette games, keno games and other types of wagering games that are commonly deployed at a casino for use by players. Play on the EGMs typically requires the player to place a wager on the outcome of game. From the player's perspective, the most unappealing feature of the games is that mathematically, over time, the EGMs are programmed to pay out a theoretical percentage of the amount wagered (referred to as “coin-in”) that is less than one hundred percent (100%). In fact, in many jurisdictions where wagering games are legal, a maximum theoretical “payout” or “payback” percentage is set by law or regulation to be less than 100%. Players know that the EGMs are programmed to provide the house with an edge. In fact, there is a general understanding among players that in order for a casino or other gaming establishment to continue to operate, the games must give the house an edge to win over time. Nevertheless, players also understand that they may get lucky over the short-term, or on any individual spin and be able to walk out of the casino a winner.

An example of a theoretical payback percentage is ninety-five percent (95%). In the case of a 95% theoretical payback slot machine game, the EGM is programmed to return 95 cents of every dollar wagered to the player. In mathematical terms, this means that the EGM is designed so that the combined value of each of the possible winning and losing outcomes, multiplied by the corresponding probability of each of the possible winning and losing outcomes respectively, when added together is 0.95. For the player, this is a losing proposition over the long-term and this is well understood by experienced casino patrons. However, the prospect of getting ahead in the short-term is what brings players to the casino in the hope that they will be a winner on any given spin, or on any given sequence of spins over a short period of time where the sample size and the true statistical probabilities may not always equate to the longer term reality that the player will lose 5 cents of every dollar wagered.

It is noted that there have been certain casino wagering games where the payback percentage exceeds 100%. Among such games have been video poker games. However, for the player to receive a payout exceeding 100% over the long-term on such games, the player must play optimal strategy on each and every hand. While experienced poker players tend to be well informed about the mathematical probabilities on any given hand, it is difficult even for them to resist going for a high payout hand when optimal strategy would dictate that they do something different. As a result, even in circumstances where a game with a theoretical payout percentage exceeds 100%, the actual payout percentage for such games is usually below 100%.

The present invention defines a system and method that overcomes the disadvantages inherent in the play of wagering games by casino patrons. In particular, the present invention recognizes that the casino business model requires that the casino set the EGMs to generate revenue for the casino but it also overcomes the need to generate revenue at the expense of the player. The present invention accomplishes this “win-win” arrangement by setting the theoretical payback percentage above 100%. The invention utilizes bulk, wholesale purchases of goods and/or services, to compensate for the differential between a typical payback percentage below 100% and a player-friendly payback percentage above 100%. These goods and/or services are acquired from third party vendors and are designed to be desirable prizes so that the player is willing to play the game in order to win both cash and non-cash prizes. At the same time, the vendor and the casino operator also receive benefits from the arrangement in the form of a new sales channel for the vendor, and a product that is more appealing to customers for the casino without a reduction in profits.

### BRIEF DESCRIPTION OF THE DRAWINGS

For a better understanding of the present invention, and to show more clearly how it functions, reference will now be made, by way of example, to the accompanying drawings. The drawings show embodiments of the present invention in which:

FIG. 1A shows an electronic gaming machine for playing a game;

FIGS. 1B-1F show computing devices for playing a game;

FIG. 2 shows an electronic gaming machine for playing a game and connected to a network controlled by a server based system;

FIG. 3A shows a group of electronic gaming machines on a network connected to a server based system and an external system;

FIG. 3B shows a group of computing devices on a network connected to a server based system;

FIG. 4 shows a sample merchandise voucher awarded to a player and subsidized by a third party;

FIG. 5A shows a sample probability table for a poker game with merchandise awards;

FIG. 5B shows a sample probability table for a slot game with merchandise awards;

FIG. 6 shows a flow chart of game play with an opportunity for a player to win merchandise awards; and

FIG. 7 shows a flow chart of game play with an opportunity for a player to win merchandise awards and having an advertising component.

### DETAILED DESCRIPTION OF THE INVENTION

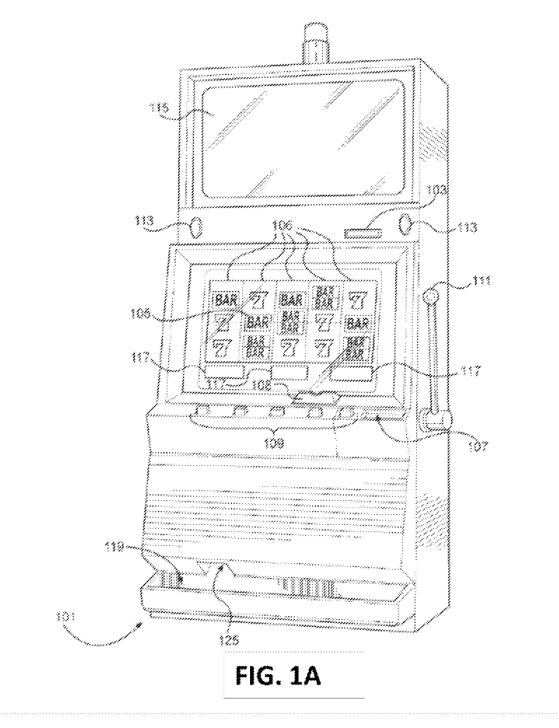

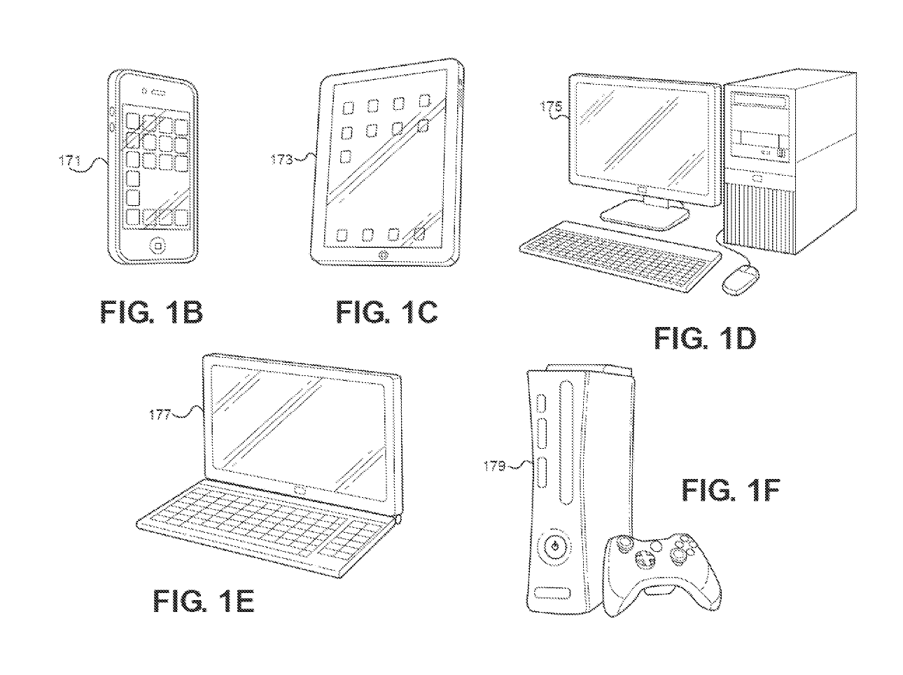

The present invention will now be described more fully with reference to the accompanying drawings. It should be understood that the invention may be embodied in many different forms and should not be construed as limited to the embodiments set forth herein. Throughout FIGS. 1-7, like elements of the invention are referred to by the same reference numerals for consistency purposes.

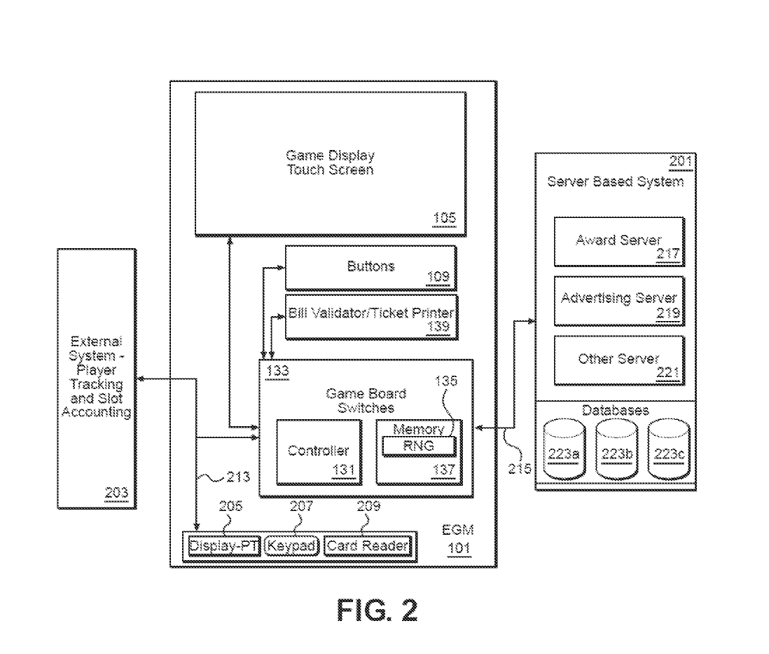

FIG. 1A shows an electronic gaming machine (“EGM”) 101 with a number of components. A display 105 is used to show game play and resulting outcomes, and may be in the form of a video display (shown), or alternatively, physical reels. Touch screen displays are included on most EGMs and provide a flexible interface for operation of EGM 101, including displaying symbols 106 during play. Other components include a bill validator (see FIG. 2) and a coin acceptor that are both housed inside EGM 101 into which bills may be inserted through bill slot 107 and coins may be inserted through coin head 108, respectively. Buttons 109 on the exterior of EGM 101 are used to control certain EGM operations in conjunction with touch screen display 105. A handle 111 may be used to initiate play of a game and speakers 113 are used to provide sounds in conjunction with game play and other EGM operations. EGMs further include a top box 115 for displaying pay tables, artwork, advertising or other types of information either on fixed glass or on other displays such as an integrated video panel. Top box 115 may be fitted with a liquid crystal display (“LCD”) screen to permit aspects of game play from either a base game or a secondary game to be shown in top box 115. Meters 117 for tracking credits available for play, amount won on a particular play, number of coins bet and other amounts are positioned near the bottom of screen 105. A coin tray 119 at the bottom of EGM 101 is used to catch coins as they are dispensed to a player. It is also common for EGM 101 to include a ticket-in, ticket-out (“TITO”) component that may be part of the bill validator housed inside of EGM 101 that may accept bar coded credits through slot 107 and for which the value of the credits is displayed on meters 117 upon a ticket being inserted.

FIGS. 1B-1F show a number of general computing devices which may be used to play a game. These figures show a smartphone 171 in FIG. 1B which may be an Apple iPhone 4S® as pictured, or any other mobile phone type device. A tablet computer 173 is shown in FIG. 1C which may be an Apple iPad 3® as pictured, or any other tablet computing device. A desktop computer 175 is shown in FIG. 1D which may be a Lenovo® machine as pictured, or any other desktop computer. A laptop computer 177 is shown in FIG. 1E which may be a Lenovo® computer or any other laptop computer. And, a home video gaming device 179 is shown in FIG. 1F which may be a Microsoft Xbox® system or any other home video system. Other types of network connected devices could also be used to play games including portable video gaming devices such as a Sony PSP®, a Nintendo GameBoy®, or an internet connected television with a browser or app capabilities. Any of these devices is capable of playing a game, including a wagering game, through an app loaded onto the device or through a website accessible using a browser on the device. In the case of the networked game, payment may be made by credit card, Paypal® or another payment service, and the RNG is run securely on server based system 201 and then delivering outcomes over the internet to be displayed on the general purpose computing device.

FIG. 2 is a block diagram of EGM 101 connected to a server based system 201 and showing certain internal components of EGM 101. All operational functions of EGM 101 are controlled by a controller 131 such as a microprocessor housed inside EGM 101 that is resident on a game board 133. The controller executes instructions that include operation of a random number generator 135 (“RNG”) that is usually implemented in software and stored in a memory 137. The internal components of EGM 101 are well known to those of ordinary skill in the art. Game outcomes are determined based on the results corresponding to the numbers selected by RNG 135. A bill validator 139 also has ticket printing capabilities. Bill validator 139 accepts currency in the form of bills, or tickets from a player and adds credit to meters 117 on EGM 101.

An external system 203 such as a player tracking system, a slot accounting system or a bonusing system may also be connected to EGM 101. These types of systems are typically connected to EGM 101 either through a separate interface board (not shown) or directly to different components of EGM 101 including but not limited to game board 133. A player tracking system may also include other components installed on EGM 101 such as a player tracking display 205, a keypad 207 and a card reader 209. These components allow for direct interaction between external system 203 and the player to receive information from the player on keypad 207 or through information on a card inserted into card reader 209, and to display information to the player on display 205. A network is established between external system 203 and EGM 101 by network connection 213. The network may be connected to all EGMs 101 in a casino or any smaller subset of EGMs 101.

Server based system 201 is also connected to EGMs 101 by a network connection 215 which may be a separate connection or the same connection as external system 203. Server based system 201 may have one or more individual servers tasked with different functions. As shown, server based system 201 has an award server 217 and an advertising server 219. Award server 217 is tasked with maintaining a database of different awards available to be offered to a player and making those awards available to the player at an appropriate time during game play. Advertising server 219 is tasked with maintaining a database of different advertisements to be displayed to a player at an appropriate time and may be based on the awards that a player chooses to play for. A third server 221 is also shown and may be used for overflow operation of either of award server 217 or advertising server 219, or for any other purpose required. Servers 217-221 are shown for illustrative purposes only. Different server configurations may be used with more or fewer servers, or a single server may be employed to handle all functions simultaneously.

Databases 223a-c storing different types of information are available to servers 217-221. In one embodiment, a database 223a may be used to store award information that is available to award server 217. Similarly, database 223b may be used to store advertising information that is available to advertising server 219. While databases 223a-c are shown as separate databases, different configurations may be used with more or fewer databases, or a single database may be employed to store all information.

In FIG. 2, EGM 101 is shown as a casino gaming device of the type depicted in FIG. 1A. It should be understood that any one or more of the general purpose computing devices—smartphone 131, tablet computer 133, desktop computer 135, laptop computer 137, or home video gaming system 139 shown in FIGS. 1B-1F—could be placed on a network connected to server based system 201. For purposes of this specification, reference to one or more EGMs 101 in an environment using a limited access intranet of the type typically found in a casino would also apply to one or more general purpose computing devices with a secure connection to a server over the internet.

It will be understood that the type of network over which data is communicated can be one of several different types of networks. The includes a Local Area Network (LAN), Wide Area Network (WAN), an intranet or the Internet. Other proprietary networks could also be used without departing from the principles of the invention. This would include such networks as a Windows network or an Ethernet network.

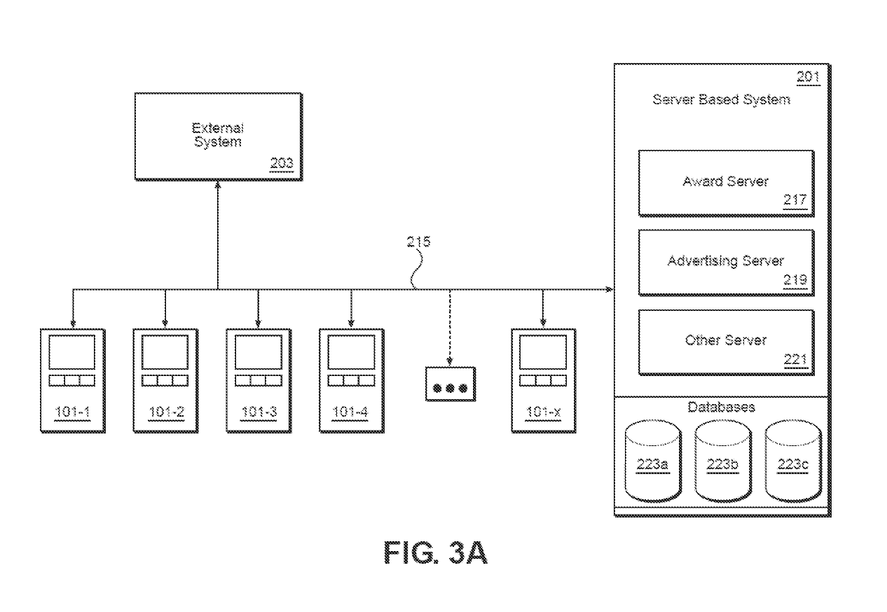

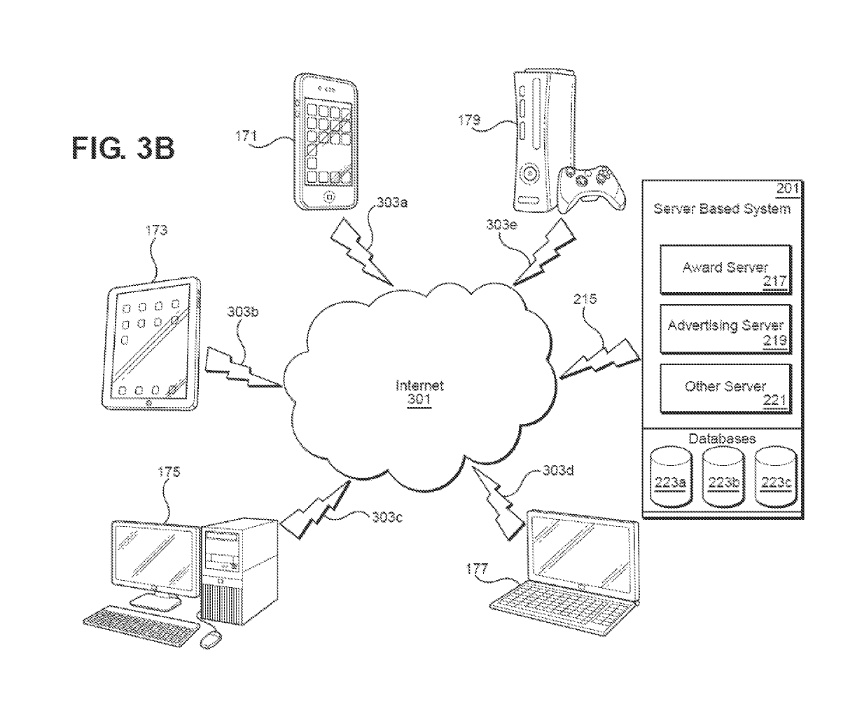

FIG. 3A is a block diagram showing a group of EGMs 101 1-x on a network connection 215 between server based system 201 and each of EGMs 101 1-x. It should be understood that the network may be set up with any number of EGMs that may number into the thousands of machines. Each of EGMs 101 1-x is also connected to external system 203 that may be a player tracking, slot accounting, bonusing or other type of system. Information is communicated between EGMs 101 and server based system 201 so that a player at any one of EGMs 101 may be offered a different set of award options that are appealing to that player. For example, one player at EGM 101-1 may enjoy travel. For that player, it may be appealing to play for travel related awards such as airline tickets, hotel stays or rental car uses, or a package of all three. Another play may be excited to win a shopping spree at a local department store, while a third player may enjoy tickets to a sporting event. For any of these awards, a voucher may be printed by ticket printer 139 of EGM 101 and dispensed to the player upon achieving a winning outcome for the selected award.

FIG. 3B shows server based system 201 connected to a network with multiple computing devices for playing games. It should be understood that the network shown in FIG. 3B operates in the same manner as the network of FIG. 3A, except that the computing devices on the network of FIG. 3B are connected over the internet 301 with each device 171-179 connected over a secure connection 303a-e to server based system 201 which connects to the internet over network connection 215. Payments can be made securely over internet 301 using connections 303a-e, and then delivered to an operator over connection 215. Similarly, the game is executed on server based system 201 using a secure RNG with the outcomes being delivered to the individual devices 171-179 over internet 301. Payments to players may be made using accounts set up with an operator of a website on which the games are run.

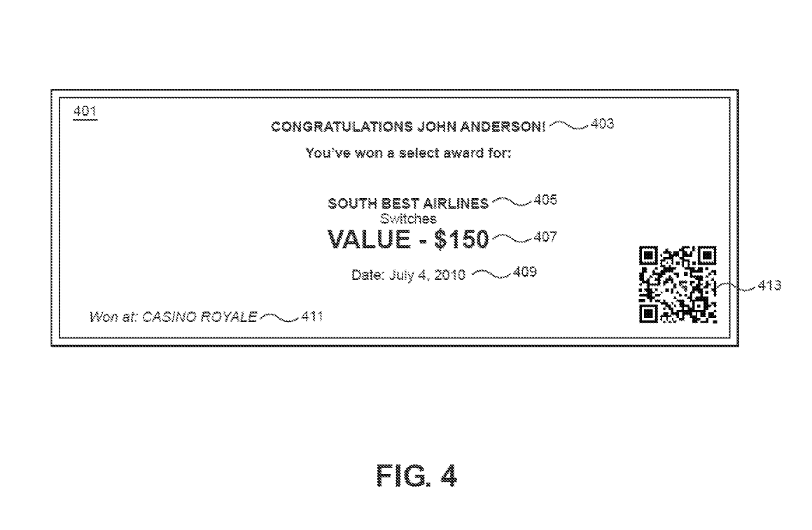

An award in the form of a printed voucher 401 is shown in FIG. 4. The particular voucher shown is for South Best Airlines and is in the amount of $150. The voucher may include various information such as a congratulatory note 403, the sponsor 405, the amount of the voucher 407, the date it was won 409, the name of the casino 411, and a bar code 413 to identify and authenticate the ticket for a particular player, and where it was won. The bar code may be a 2-dimensional type or the older one dimensional type (not shown). To use voucher 401, the player need only present the voucher to the sponsor with a personal identification to receive the value of the award. The bar code is maintained on the server in a database and provided to the sponsor so that voucher 401 may be authenticated upon presentation by the winning player.

Alternatively, printed voucher 401 may be in electronic form and sent to a player via email, text message, Twitter, or accessible through a social media site such as Facebook®, Google+®, Twitter®, etc., or on a loyalty award site. In electronic form, voucher 401 may be printed out by the player for presentation to the vendor, or simply presented to a vendor on a mobile device such as mobile phone 171 or tablet computer 173. The voucher may also be made available on a loyalty award site or sent to another individual chosen by the player as a gift.

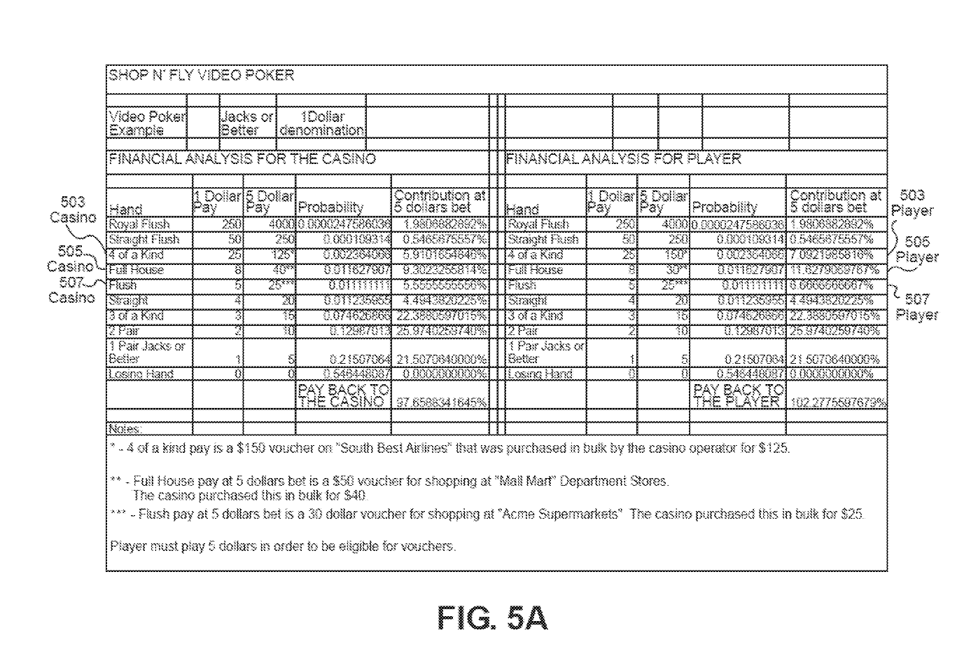

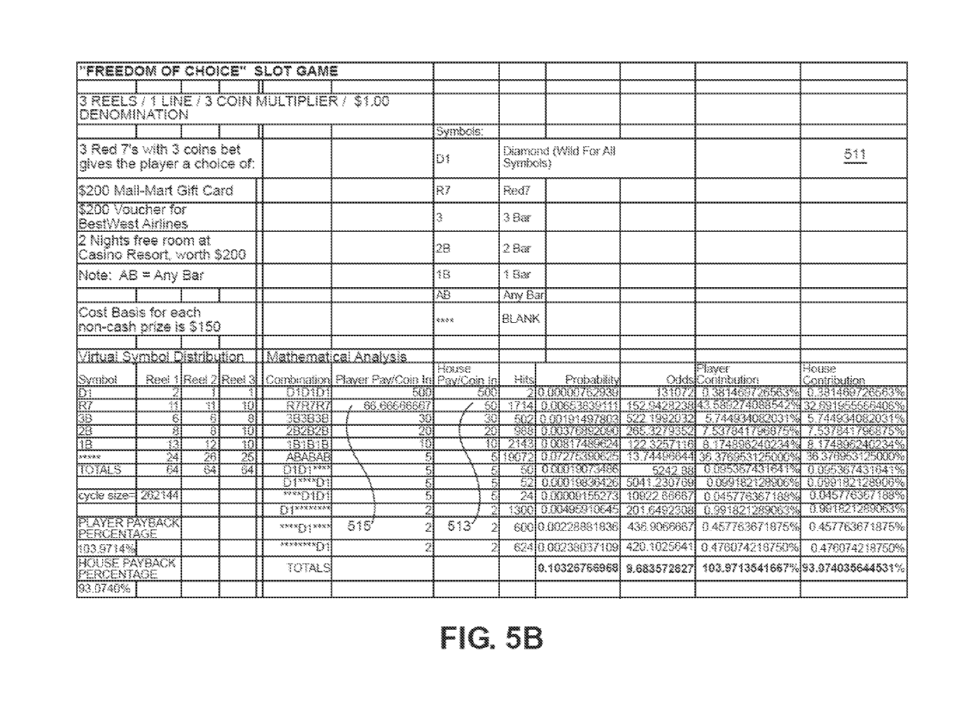

FIG. 5A is a sample probability table 501 for a game with merchandise awards. The probability table is for a poker game referred to as “Shop 'N Fly Video Poker.” The table is similar to a standard video poker table for a “Jacks or Better” video poker game with a $1 denomination. Table 501 shows a financial analysis for the casino on the left side and a financial analysis for the player on the right side for “hand,” “1 dollar pay,” “5 dollar pay,” “probability” and “contribution at 5 dollars bet” in the columns for each of the casino and player column groupings respectively. A similar calculation for “contribution at 1 dollar bet” is not included in the figure because in the sample, a $5 bet is required to win the vouchers.

As can be seen in table 501, three of the awards for a 5 dollar bet have been replaced with third party sponsored awards. These awards are for a 4-of-a-kind 503, a full house 505 and a flush 507. For each of these awards, the usual cash prize amount to the player has been substituted with a voucher from a third party entity offering the casino operating the Shop 'N Fly game a non-cash prize in the form of a voucher for products or services. In this case, the 4-of-a-kind that is usually worth a $125 cash prize to the player is replaced with a voucher award having a retail value of $150. The casino buys the $150 award for $125 (503casino) and is able to offer it to the player at a $150 value (503player) because the third party sponsor has discounted the purchase price to the casino based on volume sales or other marketing value. Since the value to the player is $150, the overall payout percentage is increased over the normal $125 payout for 4-of-a-kind

Similarly, the casino may offer the player a $50 voucher at Mall-Mart department stores for a full house. A full house is usually paid at $40 and Mall-Mart has sold the voucher to the casino for $40. The player may also get a $30 voucher at Acme Supermarkets for getting a flush which is normally paid at $25. As with the other two sponsored awards described, the $30 Acme voucher cost the casino $25. With these substitutions in the paytable, the overall payback percentage for the casino is about 97% while the overall payback percentage including the retail value of the voucher awards to the player is about 102%. The Shop 'N Fly poker game is therefore more appealing to everyone involved—the player because s/he gets the benefits of playing a game with a higher payback percentage which will pay out more over time, the casino, because it can maintain the same profitability on the game while paying more out to the player and making that player a happier and more loyal customer, and the award sponsor who makes a sale of its products or services and taps into a sales channel that it had not previously enjoyed while doing so at a reasonable cost.

In the particular sample table of FIG. 5A, the voucher and higher probability payout percentage is only offered on a 5 dollar wager. However, it is possible to offer vouchers for play on a 1 dollar wager as well. This is a design choice to be made by the game designer.

FIG. 5B shows a sample probability table for a slot game with merchandise awards. The probability table is for a slot game referred to as “Freedom of Choice Slot Game.” The table is similar to a standard slot game table for a three reel, 1 line, 3 coin multiplier in a $1 denomination. However, if the player hits 3 red 7s across the payline, the player is given a special merchandise award, which in the example of table 511 is a $200 award voucher that may be selected by the player between: 1) a Mall-Mart gift card; 2) a South Best Airlines card; or 3) 2 free nights at Casino Resort.

As can be seen in table 511, one of the awards for has been replaced with the special award selected by the player. This award is provided to the player when s/he lines up three red 7s across the payline. For this symbol combination, the usual cash prize amount to the player of $150 has been substituted with a voucher from a third party entity offering the casino operating the Freedom of Choice slot game a non-cash prize in the form of a voucher for products or services. In this case, the three red 7s combination that is usually worth a $150 cash prize to the player is replaced with a voucher award having a retail value of $200. The casino buys the $200 award for $150 as can be seen at table entry 513 (three times multiplier applied to a value of 50) and is able to offer it to the player at a $200 value as can be seen at table entry 515 (three times multiplier applied to a value of 66.666) because the third party sponsor has discounted the purchase price to the casino based on volume sales or other marketing value. Since the value to the player is $200, the overall payout percentage is increased over the normal $150 payout for three red 7s.

With this substitution in the paytable, the overall payback percentage for the casino is about 93% while the overall payback percentage to the player is about 103%. The Freedom of Choice slot game is therefore more appealing to everyone involved—the player because s/he gets the benefits of playing a game with a higher pay percentage, which will pay out more over time, the casino, because it can maintain the same profitability on the game while paying more out to the player and making that player a happier and more loyal customer, and the award sponsor who makes a sale of its products or services and taps into a sales channel that it had not previously enjoyed while doing so at a reasonable cost.

In the particular sample table of FIG. 5B, the voucher and higher probability payout percentage is only offered on a 3 coin multiplier wager. However, it is possible to offer vouchers for play on a 1 dollar wager as well. This is a design choice to be made by the game designer.

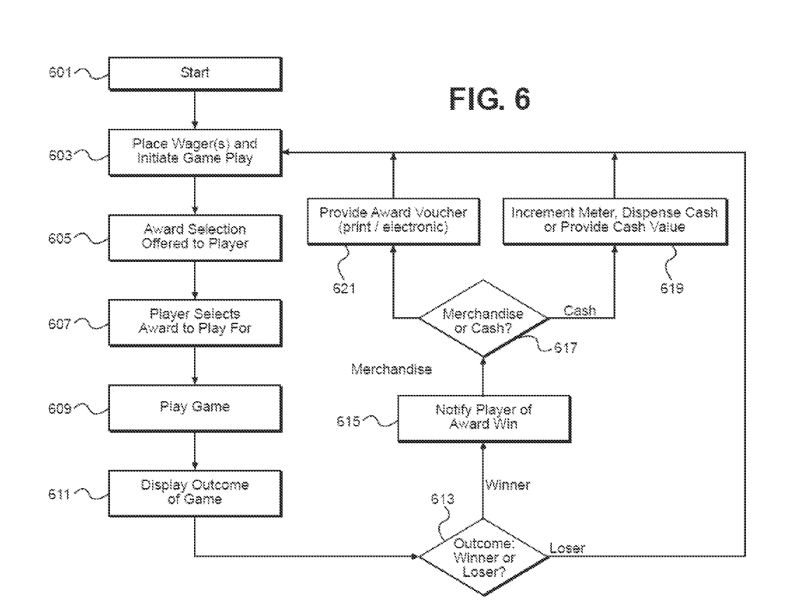

FIG. 6 shows a flow chart of game play with an opportunity for a player to win merchandise awards in the form of products and services. Start 601 represents the point at which a player sits down at EGM 101 to begin play. The player initially inserts a bill into bill slot 107 or coins into coin head 108 to put credits on the machine. These credits may be displayed to the player on a credit meter 117. The player then selects a wager amount and places a wager using buttons 109 to initiate game play at step 603. Before the game actually begins, a player is offered an award selection at step 605. The award selection may be a single step where the player is given a simple choice among 2 or more pre-determined awards at a given prize level. For the $150 prize, the player may choose a $150 voucher for: 1) an airline flight; 2) a shopping spree at a department store; or 3) a pair of tickets to a sporting event. The choices are made available to EGM 101 by server based system 201, and more particular by award server 217 from awards that are available in award database 223a. The awards are entered into system 201 by the casino operator based on agreements reached between the casino operator and third party sponsors seeking to sell merchandise through EGM 101. Award choices are updated on a continuous basis as new awards are added to database 223a by the casino operator.

To give the player greater control over award selections, an additional step may be added where the awards to be offered are broken out into different award categories. Before choosing a particular award, the player may first choose an award category such as “Travel,” “Merchandise,” or “Tickets,” although it should be understood that there may be many categories from which a player may choose. The categories are maintained on database 223a in server based system 201. Once a player has selected a category, the player is given an opportunity to select from a group of awards in the category for which to play. If a player has chosen the travel category, the player will be offered the choice of different travel awards such as a flight voucher on an airline, a hotel stay voucher or a car rental voucher. If the player chooses the Merchandise category, s/he may play for a gift voucher of the specified amount at a department store or a shopping spree worth a particular amount at a grocery store. Similarly, for the Ticket category, the player may choose between concert tickets, a sporting event or a play, among many other potential choices.

Selection of the award category and/or the particular award is done on EGM 101 by presenting selection on display 105 of EGM 101 and offering the player an opportunity to make a selection through buttons 109 on touch screen game display 105 or through the use of buttons 109 on EGM 101. Once the player has selected the award for which s/he wants to play at step 607, the game is played at step 609 including appropriate game graphics shown on display 105 and game sounds from speakers 113. In this step, RNG 135 is also executed on controller 131 and a game outcome is chosen. Once the outcome is reached, the outcome is displayed on game display 105 for the player to see at step 611. It is determined whether the outcome is a winner or loser at step 613. If it is a losing outcome, the player is returned to step 603 to start the process over again. If it is a winning outcome, the player is notified that s/he has won at step 615.

Once it has been established that the player has won at step 613 and s/he has been notified at step 615, the award must be provided to the player. It must be determined whether the player was eligible for a merchandise award at step 617. If not, the player is paid out by incrementing credit meter 117 for the appropriate amount of cash or by dispensing cash or a ticket voucher cash equivalent from ticket printer 139 at step 619, or alternatively the player may be provided with the voucher electronically by sending it in an email message, a text message or a twitter message, or by making the voucher electronically available in the player's online loyalty account, or through a social media site such as Facebook, or though any other form. The voucher may also be sent as a gift to an individual of the player's choosing, either electronically or in printed form. If the player is eligible for a merchandise award, a voucher for the merchandise is printed from ticket printer 139, or otherwise provided to the player as described with respect to the award information at step 621 and including a bar code or some other form of data security to ensure that the voucher has a unique identification that can be confirmed when presented by the player. The bar code is provided by award server 217 and that same bar code is delivered to the sponsor so that it can be authenticated by the sponsor when presented for use by the player. The printing or transmission of the voucher is also confirmed to award server 217 which removes the award from the available inventory of awards on database 223a.

Once the award has been provided to the player either at step 619 or 621, the player is returned to step 603 to play the next game. It should be understood that a player preference setting may be established to allow the player to play multiple games in sequence for the same awards without making award selections each time through the sequence of the flow chart of FIG. 6. In that case, the player may be prompted on display 105 to indicate that s/he would like to continue to play for the same awards until a cash out or other event occurs.

While FIG. 6 describes a process in which a player makes a choice of an award type and a particular award (see description of steps 605, 607), it should be understood that these steps may be eliminated and server 201 may offer a predetermined award set by the operator without the player's involvement in the selection. In that case, the player would be informed of the award s/he is playing for at the start of the game. The award may also be a mystery award offered from a group of awards and chosen at random by server 201.

An option that may be implemented is to offer the player the ability to exchange an award. This includes exchanging a cash award for a non-cash award, exchanging a non-cash award for a cash award or exchanging a non-cash award for another non-cash award. This option may be implemented as part of game play on EGM 101 where award server 201 makes such offers available at any time after an award has been provided to the player and the player can elect to make an exchange using buttons 109 on touch screen 105 or on the panel of EGM 101. Or, a voucher exchange may be made available to a player at another location in the casino establishment.

Another option that may be implemented in the invention is an advertising element. By adding advertising to various steps of the game, a fee from the advertiser(s) can be collected and the advertising may be used by the casino operator to further increase the payback percentage to the player. This may be done either by applying the full amount collected by the casino for the advertising to the payout amounts in the pay table, or where the casino takes an advertising fee from the advertising revenue but contributes some portion of the advertising revenue to the awards for payout thereby increasing the theoretical payback percentage. Alternatively, the advertising revenue may be given to the player, either in whole or in part to enhance the player's experience.

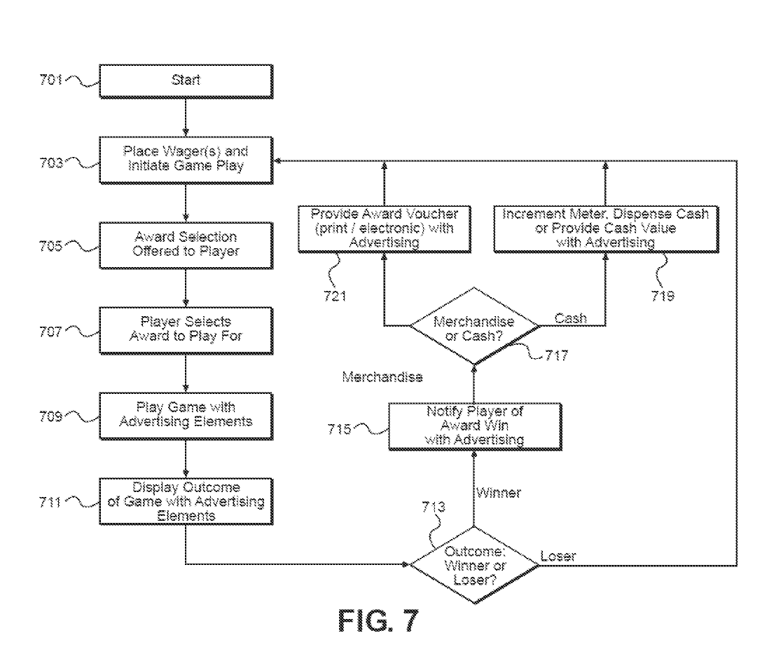

The advertising element is described with respect to FIG. 7 which shows a flow chart of game play with an opportunity for a player to win merchandise awards and having advertising elements. Start 701 represents the point at which a player sits down at EGM 101 to begin play. The player initially inserts a bill into bill slot 107 or coins into coin head 108 to put credits on the machine. These credits may be displayed to the player on a credit meter 117. The player then selects a wager amount and places a wager using buttons 109 to initiate game play at step 703. Before the game actually begins, a player is offered an award selection at step 705. The award selection may be a single step where the player is given a simple choice among 2 or more pre-determined awards at a given prize level. For the $150 prize, the player may choose a $150 voucher for: 1) an airline flight; 2) a shopping spree at a department store; or 3) a pair of tickets to a sporting event. The choices are made available to EGM 101 by server based system 201 and more particular by award server 217 from awards that are available in award database 223a. The awards are entered into system 201 by the casino operator based on agreements reached between the casino operator and third party sponsors seeking to sell merchandise through EGM 101. Award choices are updated on a continuous basis as new awards are added to database 223a by the casino operator.

To give the player greater control over award selections, an additional step may be added where the awards to be offered are broken out into different award categories. Before choosing a particular award, the player may first choose an award category such as “Travel,” “Merchandise,” or “Tickets,” although it should be understood that there may be many categories from which a player may choose. The categories are maintained on database 223a in server based system 201. Once a player has selected a category, the player is given an opportunity to select from a group of awards in the category for which to play. If a player has chosen the travel category, the player will be offered the choice of different travel awards such as a flight voucher on an airline, a hotel stay voucher or a car rental voucher. If the player chooses the Merchandise category, s/he may play for a gift voucher of the specified amount at a department store or a shopping spree worth a particular amount at a grocery store. Similarly, for the Ticket category, the player may choose between concert tickets, a sporting event or a play, among many other potential choices.

Selection of the award category and/or the particular award is done on EGM 101 by presenting selection on display 105 of EGM 101 and offering the player an opportunity to make a selection through buttons 109 on touch screen game display 105 or through the use of buttons 109 on EGM 101. When the player makes the award selections including either or both of the category choice and/or particular award choice, that information is captured and delivered to award server 217 where it is stored on database 223a for reference about the player's choices. The choices, as well as other information about the player from sources such as the player tracking system, hotel database and any other accessible sources that provide data about a player are gathered over time and used to build a player profile. The player profile will allow the advertising server to target particular ads that are of interest to a particular player and will be effective in selling particular vouchers or other merchandise either inside or outside the casino. The player profile information may also be used to prioritize award selections offered to the player.

Once the player has selected the award for which s/he wants to play at step 707, the game is played at step 709, including appropriate game graphics shown on display 105 and game sounds from speakers 113. During play, advertising server 219 may deliver particular play symbols or other advertising graphics to display 105 that incorporate advertisements based on the player's preferences that are gleaned from the player profile. In a manner similar to how sponsored awards are purchased by a casino operator to be available to a player for delivery by award server 217 from award database 223a upon achieving a certain game outcome, the advertising content is sold by the casino operator to advertisers. The particular advertisements, including how and when they are presented is up to the casino, the game manufacturer and/or the advertiser. Once finalized, the advertising content is stored on database 223b for delivery to EGM 101 by advertising server 219. An example of a particular advertisement would be to place a company logo on the card backs of a poker game. Alternatively, the advertiser could have their logo appear as a symbol in a spinning reel slot or video slot game.

Returning to step 709, RNG 135 is executed on controller 131 and a game outcome is chosen. Once the outcome is reached, the outcome is displayed on game display 105 for the player to see at step 711 which outcome and the screen on which it is displayed may incorporate advertising content including within the play symbols. The advertising content is delivered by advertising server 221 from database 223b. It is then determined whether the outcome is a winner or loser at step 713. If it is a losing outcome, the player is returned to step 703 to start the process over again. If it is a winning outcome, the player is notified that s/he has won at step 715 possibly accompanied by other targeted advertising content delivered by advertising server 221 from database 223b.

Once it has been established that the player has won at step 713 and s/he has been notified at step 715, the award must be provided to the player. It must be determined whether the player was eligible for a merchandise award at step 717. If not, the player is paid out by incrementing credit meter 117 for the appropriate amount of cash or by dispensing cash or a ticket voucher cash equivalent from ticket printer 139 at step 719 which also may include advertising content. Alternatively the player may be provided with the voucher electronically by sending it in an email message, a text message or a twitter message, or by making the voucher electronically available in the player's online loyalty account, or through a social media site such as Facebook, or though any other form. If the player is eligible for a merchandise award, a voucher for the merchandise is printed from ticket printer 139, or otherwise provided to the player as described with respect to the award information at step 721, including a bar code or some other form of data security to ensure that the voucher has a unique identification that can be confirmed when presented by the player. The bar code is provided by award server 217 and that same bar code is delivered to the sponsor so that it can be authenticated by the sponsor when presented for use by the player. The printing or transmission of the voucher is also confirmed to award server 217 which removes the award from the available inventory of awards on database 223a. When printing or transmitting the award voucher at step 721, such award voucher may include advertising content delivered by advertising server 221.

Once the award has been provided to the player either at step 719 or 721, the player is returned to step 703 to play the next game. It should be understood that a player preference setting may be established to allow the player to play multiple games in sequence for the same awards without making award selections each time through the sequence of the flow chart of FIG. 7. In that case, the player may be prompted on display 105 to indicate that s/he would like to continue to play for the same awards until a cash out or other event occurs.

While FIG. 7 describes a process in which a player makes a choice of an award type and a particular award (see description of steps 705, 707), it should be understood that these steps may be eliminated and server 201 may offer a predetermined award set by the operator without the player's involvement in the selection. In that case, the player would be informed of the award s/he is playing for at the start of the game. The award may also be a mystery award offered from a group of awards and chosen at random by server 201.

An option that may be implemented is to offer the player the ability to exchange an award. This includes exchanging a cash award for a non-cash award, exchanging a non-cash award for a cash award or exchanging a non-cash award for another non-cash award. This option may be implemented as part of game play on EGM 101 where award server 201 makes such offers available at any time after an award has been provided to the player and the player can elect to make an exchange using buttons 109 on touch screen 105 or on the panel of EGM 101. Or, a voucher exchange may be made available to a player at another location in the casino establishment.

While the invention has been described with respect to the figures, it will be appreciated that many modifications and changes may be made by those skilled in the art without departing from the spirit of the invention. For example, any particular game incorporating the invention may have a set paytable where the player is not given a choice of awards. Instead, the awards for any given outcome are set and may not be changed by the player. It's also possible to implement the invention where any given outcome may be eligible for any one of a group of different awards where the award provided to the player is selected at random from the group. Any variation and derivation from the above description and drawings are included in the scope of the present invention as defined by the claims.

What is claimed is:

1. A networked system of electronic gaming machines (“EGMs”) on which a player wagers on a game played on a particular EGM with an opportunity to win an award, comprising:
a random number generator implemented in software for generating random numbers that determine the outcome of the game and that correspond to a predefined set of game outcomes including winning and losing outcomes;
a display for displaying game play including game outcomes to a player; and
a controller which executes the random number generator software and controls game play on the electronic gaming machine wherein the theoretical payback percentage of the retail value of awards provided for winning outcomes on the game exceeds one hundred percent; and
an award generator in communication with the controller for providing an award to a player in the event that a winning outcome is achieved wherein the awards for a winning outcome include at least one cash award and at least one non-cash award wherein the non-cash award is a type from the group comprising: a) a printed voucher that may be used to purchase a product or service, or portion thereof; b) an electronic or magnetic card holding value that may be used to purchase a product or service, or portion thereof; c) a physical item; d) an electronic voucher provided to the player; or e) another non-cash item of value.

2. The system of claim 1 further comprising a user interface on which the player may select preferences for the non-cash award to be provided to the player upon achieving a winning outcome on the game.

3. The system of claim 2 further comprising an award server for determining the particular non-cash awards available and for determining the particular non-cash awards to be offered to a particular player based on preferences selected by the player.

4. The system of claim 3 further comprising a database for storing information about the player and which information is used by the award server to determine the particular non-cash awards to be offered to a particular player.

5. The system of claim 4 wherein the award server gathers information about a particular player and stores the information in the database.

6. The system of claim 1 further comprising an advertising server connected to the network for generating advertisements that are displayed to the player on the display of an EGM or on a display within viewing distance of an EGM at which a player is playing.

7. The system of claim 6 wherein an advertisement is displayed in a game element or portion thereof in a game played on an EGM.

8. The system of claim 6 wherein revenue generated by advertisements is used to increase the payback percentage of a game on an EGM.

9. The system of claim 6 wherein revenue generated by advertisements is used to pay in whole or in part for non-cash awards provided to a player.

10. The system of claim 1 wherein an award exchange opportunity is provided to the player to make an exchange any one of the types from the group: a) a cash award for a non-cash award; b) a non-cash award for a cash award; or c) a non-cash award for a different non-cash award.

11. The system of claim 6 wherein an advertisement is displayed on the display during game play.

12. The system of claim 6 wherein the revenue generated by advertisements is provided to the player in whole or in part.

13. The system of claim 1 wherein the EGMs are dedicated gaming machines located in a casino.

14. The system of claim 1 wherein the EGMs are computing devices connected to the internet.

15. The system of claim 14 wherein the computing devices are at least one of the type from the group comprising: a) smartphones; b) tablet computers; c) laptop computers; d) desktop computers; e) computing terminals; f) home video gaming devices; or g) portable video gaming devices.

16. The method of claim 17 wherein the electronic voucher may be of a type from the group comprising: a) an email; b) a text message; c) on a social media site; or d) a designation to a third party.

17. In a networked system including at least one electronic gaming machine (“EGM”) and a server with a database for maintaining records of awards, a method of playing a game on an EGM having a controller that executes a random number generator program implemented in software and a display, comprising:
placing a wager to initiate play of a game on the EGM;
providing a plurality of game outcomes including at least one outcome that results in a cash award and at least one outcome that results in a non-cash award, wherein the theoretical payback percentage of the retail value of the awards provided for winning outcomes exceeds one hundred percent and the non-cash award is a type from the group comprising: a) a printed voucher that may be used to purchase a product or service, or portion thereof; b) an electronic or magnetic card holding value that may be used to purchase a product or service, or portion thereof; c) a physical item; d) an electronic voucher; or e) another non-cash item of value;
selecting a random number upon running the random number generator on the controller that is converted to one of the plurality of game outcomes;
displaying the game outcome on the display;
determining whether the game outcome is a winning outcome, wherein if the game outcome is a winning outcome, determining whether the winning outcome is one for a cash award or a non-cash award;
awarding a cash award for a winning outcome corresponding to the cash award; and
awarding a non-cash award for a winning outcome corresponding to the non-cash award.

18. The method of claim 17 further comprising providing a user interface on which the player may select preferences for the non-cash award to be provided to the player upon achieving a winning outcome on the game.

19. The method of claim 18 further comprising providing an award server for determining the particular non-cash awards available and for determining the particular non-cash awards to be offered to a particular player based on preferences selected by the player.

20. The method of claim 19 further comprising providing a database for storing information about the player and which information is used by the award server to determine the particular non-cash awards to be offered to a particular player.

21. The method of claim 20 wherein the award server gathers information about a particular player and stores the information in the database.

22. The method of claim 17 further comprising providing an advertising server connected to the network for generating advertisements that are displayed to the player on the display of an EGM or on a display within viewing distance of an EGM at which a player is playing.

23. The method of claim 22 wherein an advertisement is displayed in a game element or portion thereof in a game played on an EGM.

24. The method of claim 22 wherein revenue generated by advertisements is used to increase the payback percentage of a game on an EGM.

25. The method of claim 22 wherein revenue generated by advertisements is used to pay in whole or in part for non-cash awards provided to a player.

26. The method of claim 17 wherein an award exchange opportunity is provided to the player to exchange any one of the types of exchanges from the group: a) a cash award for a non-cash award; b) a non-cash award for a cash award; or c) a non-cash award for a different non-cash award.

27. The method of claim 22 wherein an advertisement is displayed on the display during game play.

28. The method of claim 18 wherein the revenue generated by advertisements is provided to the player in whole or in part.

29. The method of claim 17 wherein the EGMs are dedicated gaming machines located in a casino;

30. The method of claim 17 wherein the EGMs are computing devices connected to the internet.

31. The method of claim 17 wherein the computing devices are at least one of the type from the group comprising: a) smartphones; b) tablet computers; c) laptop computers; d) desktop computers; e) computing terminals; f) home video gaming devices; or g) portable video gaming devices.

32. The method of claim 17 wherein the electronic voucher may be of a type from the group comprising: a) an email; b) a text message; c) on a social media site; or d) a designation to a third party.
